(19) United States
(12) Patent Application Publication
(10) Pub. No.: US 2015/0327163 A1
(43) Pub. Date: Nov. 12, 2015

(54) METHOD AND APPARATUS FOR SELECTING MOBILITY ANCHOR IN MOBILE COMMUNICATION SYSTEM

(71) Applicants: Samsung Electronics Co., Ltd, Gyeonggi-do (KR); Korea University Research and Business Foundation, Seoul (KR)

(72) Inventors: Sang-Heon Pack, Seoul (KR); Han-Eul Ko, Seoul (KR); Gi-Won Lee, Seoul (KR)

(21) Appl. No.: 14/709,940

(22) Filed: May 12, 2015

(30) Foreign Application Priority Data
May 12, 2014 (KR) 10-2014-0056586

(51) Int. Cl. H04W 48/20; H04W 48/02; H04W 64/00

(52) U.S. Cl. CPC H04W 48/20; H04W 64/003; H04W 48/02

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). The present disclosure relates to a method and apparatus for selecting a mobility anchor (MA) in a mobile communication system. A method of operating a controller which selects an MA comprises: receiving a bearer configuration request signal from a terminal; acquiring load information for each of a plurality of MAs and mobility information of the terminal; and determining an MA of the terminal on the basis of the load information of each of the plurality of MAs and the mobility information of the terminal.

### CROSS-REFERENCE TO RELATED APPLICATION AND CLAIM OF PRIORITY

The present application claims the benefit under 35 U.S.C. §119(a) to Korean Application Serial No. 10-2014-0056586, which was filed in the Korean Intellectual Property Office on May 12, 2014, the entire content of which is hereby incorporated by reference.

### TECHNICAL FIELD

The present disclosure relates to a mobile communication system and, more particularly, to a method and an apparatus for selecting an optimum mobility anchor (MA) to transmit a packet of a mobile terminal.

### BACKGROUND

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

A mobile communication network supports connection between a mobile terminal and a public data network (PDN). An agent which serves as a mobility anchor exists between the mobile terminal and the PDN. For example, traffic, which is transmitted from the PDN to the mobile terminal, is transmitted through the agent. Further, since the agent serves as a MA between a 3GPP access system and a PDN access system, bottleneck, a non-optimal problem of a traffic routing path, etc. are generated. In addition, as the number of mobile terminals increases and the amount of data used by mobile terminals exponentially increases, such problems are being more highlighted.

In order to resolve such problems, 3GPP provides a method of locally installing a plurality of MAs to select an MA closest to the mobile terminal. However, although a load balancing effect can be obtained through such a method, when a mobile terminal moves, time consumed while transmitting a packet to the mobile terminal may lengthen.

### SUMMARY

To address the above-discussed deficiencies, it is a primary object to provide a method and an apparatus for selecting an optimal MA to transmit a packet to a mobile terminal in consideration of mobility of the mobile terminal and load information of an MA in a mobile communication system.

Various embodiments of the present disclosure provide a method and an apparatus for selecting an optimal MA and an optimal access router (AR) to transmit a packet to a mobile terminal in consideration of mobility of the mobile terminal and load information of an MA in a mobile communication system.

Various embodiments of the present disclosure provide a method and apparatus for transmitting a packet through an optimal MA using a path switching scheme in a mobile communication system.

Various embodiments of the present disclosure provide a method and apparatus for transmitting a packet through an optimal MA and an optimal AR using a path forwarding scheme in a mobile communication system.

In accordance with various embodiments of the present disclosure, a method of operating a controller that selects a MA in a mobile communication system is provided. The method includes: receiving a bearer configuration request signal from a terminal; acquiring load information for each of a plurality of MAs and mobility information of the terminal: and determining an MA of the terminal on the basis of the load information of each of the plurality of MAs and the mobility information of the terminal.

In accordance with various embodiments of the present disclosure, a controller apparatus for selecting an MA in a mobile communication system is provided. The apparatus includes: a transmission/reception unit that receives a bearer configuration request signal from a terminal; and a controller that acquires load information for each of a plurality of MAs and mobility information of the terminal, and determines an MA of the terminal on the basis of the load information of each of the plurality of MAs and the mobility information of the terminal.

According to various embodiments of the present disclosure, in a mobile communication system, an optimal MA and/or an optimal AR to transmit a packet to a mobile terminal are selected in consideration of mobility of the mobile terminal and load information of each MA. Therefore, a load balancing effect of the MA is maximized and time consumed while transmitting a packet to the mobile terminal is minimized.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mobile communication system according to various embodiments of the present disclosure;

FIG. 2 illustrates a controller according to various embodiments of the present disclosure;

FIG. 3 illustrates a process of operating a controller corresponding to a packet forwarding scheme according to various embodiments of the present disclosure;

FIG. 4 illustrates a packet transmission path of a packet forwarding scheme according to various embodiments of the present disclosure;

FIG. 5 illustrates a process of operating a controller corresponding to a packet switching scheme according to various embodiments of the present disclosure;

FIG. 6 illustrates a packet transmission path of a packet switching scheme according to various embodiments of the present disclosure;

FIG. 7 illustrates an initial access procedure of a terminal in a mobile communication system according to various embodiments of the present disclosure;

FIG. 8 illustrates signal flow when an internal mobile terminal serves as a client in a packet forwarding scheme according to various embodiments of the present disclosure;

FIG. 9 illustrates signal flow when an internal mobile terminal serves as a client in a path switching scheme according to various embodiments of the present disclosure;

FIG. 10 illustrates signal flow when an internal mobile terminal serves as a server in a packet forwarding scheme according to various embodiments of the present disclosure; and

FIG. 11 illustrates signal flow when an internal mobile terminal serves as a server in a path switching scheme according to various embodiments of the present disclosure.

### DETAILED DESCRIPTION

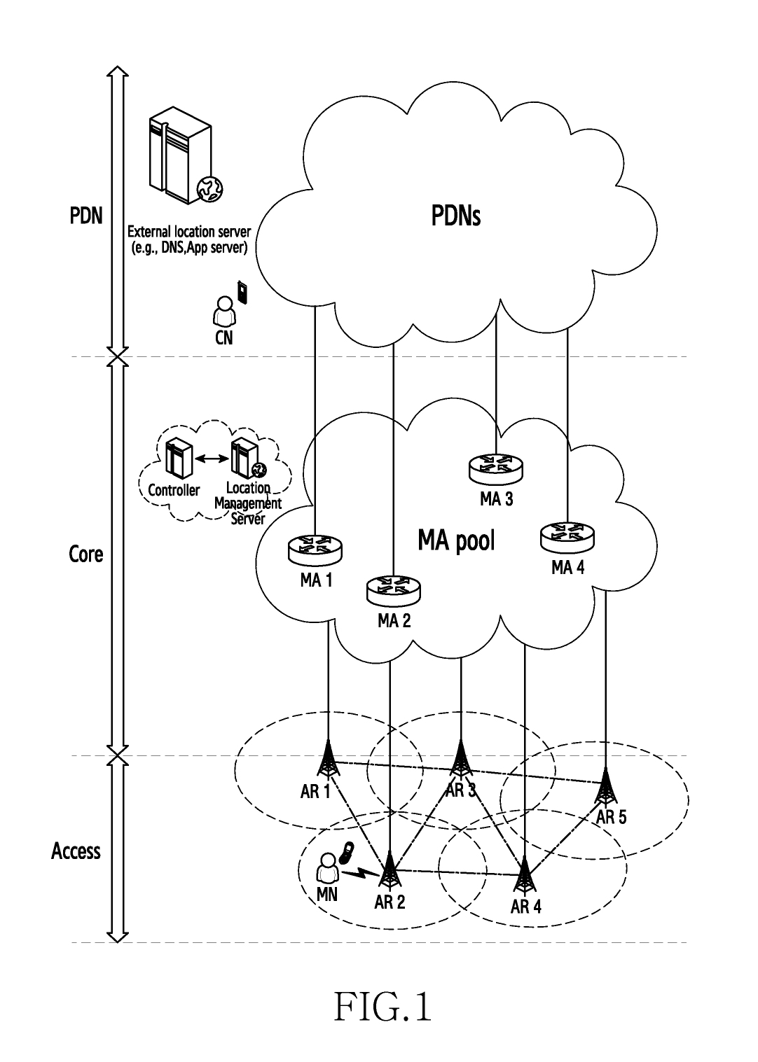

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device.

Hereinafter, exemplary embodiments of the present disclosure will be described with reference to the accompanying drawings. Further, in the following description of the present disclosure, a detailed description of known functions or configurations incorporated herein will be omitted when it may make the subject matter of the present disclosure rather unclear. Further, terms described later are defined in consideration of functions of the present disclosure, but may vary according to the intention or convention of a user or operator. Accordingly, the definitions of the terms should be made on the basis of the overall context of the embodiments.

FIG. 1 illustrates a mobile communication system according to various embodiments of the present disclosure.

Referring to FIG. 1, a mobile communication network according to various embodiments of the present disclosure includes a public data network (PDN), a mobility anchor (MA), an access router (AR), and a mobile terminal. At this time, at least one MA and at least one AR serves as a mobility anchor between the mobile terminal and the PDN, and packets, which are transmitted from the PDN to the mobile terminal, are transmitted through the at least one MA and the at least one AR.

The MA according to various embodiments of the present disclosure is installed at a part of an AR and in a partial area of a core network. Further, the at least one MA constitutes one MA pool, and the MA pool is managed through a control plane (such as a mobility management entity; MME). In certain embodiments, an entity, which manages a control plane, is called a controller, and the controller, according to various embodiments of the present disclosure, receives an MA allocation request from the mobile terminal, select an optimum MA in consideration of state information of the MA pool and mobility of the mobile terminal, and allocate the selected optimum MA to the mobile terminal. Further, the controller selects an AR corresponding to a location to which the mobile terminal is predicted to move and allocate the selected AR to the mobile terminal, according to a packet transmission scheme. For example, the controller selects only an MA when the mobile communication system supports a path switching scheme, and selects an MA and an AR when the mobile communication system supports a packet forwarding scheme.

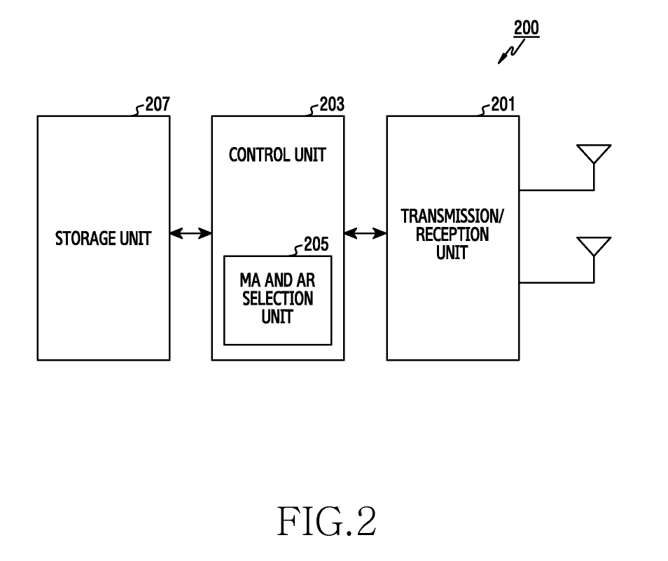

FIG. 2 illustrates a controller according to various embodiments of the present disclosure.

Referring to FIG. 2, a controller includes a transmission/reception unit 210, a control unit 203, and a storage unit 207.

The transmission/reception unit 201 transmits or receives a signal to or from a terminal or transmits or receives a signal to or from an MA, through an AR, under a control of the control unit 203. For example, the transmission/reception unit 201 receives an MA allocation request signal from a mobile terminal through an AR. In addition, the transmission/reception unit 201 receives information on a packet arrival rate from each of MAs constituting the MA pool and transmits a signal to allocate an MA or an AR, which are selected under the control of the controller 203, to a mobile terminal. At this time, when only the MA is selected under the control of the control unit 203, the transmission/reception unit 210 transmits a signal to allocate the selected MA to a mobile terminal. Although the transmission/reception unit 201 is configured by one module in various embodiments of the present disclosure, the transmission/reception unit 201 can be separately configured by a transmission unit and a reception unit according to a design scheme.

The control unit 203 controls and processes overall operations of the controller, and control and process overall operations for selecting an optimum MA or AR for a mobile terminal.

In particular, the control unit 203 includes an MA and AR selection unit 205 to select only an MA for transmitting a packet to a terminal or select both an MA and an AR. The MA and AR selection unit 205 selects only an MA or both an MA and an AR on the basis of state information of an MA pool and mobility of a terminal, and control and process a function of allocating the selected MA or the selected MA and AR to the corresponding terminal. The MA and AR selection unit 205 controls and processes a function of generating a data tunnel through which a packet is transmitted between the MA and the terminal on the basis of the allocated MA or the allocated MA and AR. For example, when a packet forwarding scheme is supported, the MA and AR selection unit 205 selects an MA and an AR on the basis of the state information of the MA pool and the mobility of the terminal, allocates the selected MA and the selected AR to the corresponding terminal, and generates a data tunnel through which a packet is transmitted to the corresponding terminal through the allocated MA and the allocated AR. When an AR corresponding to the location of the terminal and the allocated AR are different from each other due to the movement of the terminal, the MA and AR selection unit 205 controls a function of generating a data tunnel such that the allocated AR forwards a packet to the AR corresponding to the location of the terminal. When a path switching scheme is supported, the MA and AR selection unit 205 selects an MA on the basis of the state information of the MA pool and the mobility of the terminal, allocate the selected MA to the corresponding terminal, and then generate a data tunnel through which a packet is transmitted to the corresponding terminal through the allocated MA and the AR corresponding to the location of the terminal.

The MA and AR selection unit 205 receives a packet arrival rate of each MA from the corresponding MA in order to select an MA, which is to transmit a packet to a terminal which has requested MA allocation, among MAs constituting an MA pool. The MA and AR selection unit 205 calculates a load rate of each MA on the basis of the received packet arrival rate of an MA, selects at least one MA on the basis of the load rate of each MA, and configures a candidate MA set including the at least one selected MA. For example, the MA and AR selection unit 205 generates and stores a packet arrival rate table for each MA as in Table 1 below on the basis of the MA packet arrival rate received from the MAs included in the MA pool and calculates a load rate of each MA on the basis of the packet arrival rate table for each MA. The MA and AR selection unit 205 selects the predetermined number of MAs having a load rate lower than a preset threshold load rate, as a candidate MA and configures a candidate MA set including the selected candidate MA. When there is no MA having a load rate lower than the preset threshold load rate, the MA and AR selection unit 205 configures a candidate MA set including all MAs.

According to various embodiments of the present disclosure. Table 1 denotes a packet arrival rate for a unit time for each of MA 1 to MA N included in an MA pool.

TABLE 1

| | 1 | 2 | 3 | . . . | T |
|---|---|---|---|---|---|
| MA 1 | 5 | 8 | 7 | . . . | 6 |
| MA 2 | 6 | 5 | 8 | . . . | 7 |
| MA 3 | 13 | 15 | 13 | . . . | 14 |
| . . . | | | | . . . | |
| MA N | 10 | 12 | 9 | . . . | 11 |

For example, Table 1 denotes that MA 1 receives 5 packets during a time corresponding to a unit time 1, and receives 8 packets during a time corresponding to a unit time 2. Further, Table 1 denotes that MA 2 receives 6 packets during a time corresponding to a unit time 1, and receives 5 packets during a time corresponding to a unit time 2. Here, the packet arrival rate for a unit time of each MA denotes the number of packets received during a unit time from at least one AR or a node of an external PDN.

Further, the MA and AR selection unit 205 selects at least one candidate AR on the basis of probability information on which a terminal is handed off from an AR, a session of which starts within a session start section, to another AR and configures a candidate AR set including the selected candidate AR. For example, the MA and AR selection unit 205 configures a candidate AR set on the basis of an average session duration time according to a type of a session as represented in Table 2, an average residence time in an AR as represented in Table 3, or mobility information between ARs indicating a probability that a terminal moves from a specific AR to another AR as represented in Table 4. In more detail, the MA and AR selection unit 205 calculates the number of handoffs, which is predicted to be performed by the corresponding terminal, on the basis of the average residence time in each AR and the average session duration time of a session type requested by the corresponding terminal, and configure a candidate AR set on the basis of the calculated number of handoffs.

According to various embodiments of the present disclosure, Table 2 denotes an average session duration time according to a type of a session.

TABLE 2

Type

| | voice | file | video | . . . |
|---|---|---|---|---|
| Time | 320 | 1200 | 450 | . . . |

For example, Table 2 denotes that an average duration time of a session for a voice service of a terminal is 320, an average duration time of a session for a file service is 1200, and an average duration time of a session for a video service is 450. The MA and AR selection unit 205 individually stores, in the storage unit 207, the average session duration time according to a session type as in Table 2 with respect to each terminal, stores the average session duration time with respect to each specific terminal group, or stores the average session duration time for each time zone. For example, the MA and AR selection unit 205 controls a function of storing, in the storage unit 207, the average session duration time according to a session type with respect to each group configured by terminals having similar mobility or terminals having similar call patterns. Further, the MA and AR selection unit 205 controls a function of storing, in the storage unit 207, the average session duration time according to a session type for each time zone.

According to various embodiments of the present disclosure. Table 3 denotes an average residence time in each AR.

TABLE 3

AR

| | AR 1 | AR 2 | AR 3 | . . . |
|---|---|---|---|---|
| Time | 80 | 530 | 120 | . . . |

For example, Table 3 denotes that a time during which a terminal stays on average in AR 1 is 80, a time during which a terminal stays on average in AR 2 is 530, and a time during which a terminal stays on average in AR 3 is 120. The MA and AR selection unit 205 individually stores, in the storage unit 207, the average residence time as in Table 3 with respect to each terminal, stores the average residence time with respect to each specific terminal group, or stores the average residence time for each time zone. For example, since a time during which a terminal stays in each AR changes according to a traffic situation for each time zone, and particularly, a time during which a terminal stays in each AR for each time zone changes according to a job characteristic, the MA and AR selection unit 205 stores, in the storage unit 207, the average residence time in each AR with respect to each time zone.

According to various embodiments of the present disclosure, Table 4 denotes a movement probability between one AR and another AR.

TABLE 4

| | AR 1 | AR 2 | AR 3 | . . . |
|---|---|---|---|---|
| AR 1 | 0 | 0.3 | 0.4 | . . . |
| AR 2 | 0.2 | 0 | 0.6 | . . . |
| AR 3 | 0.5 | 0.2 | 0 | . . . |
| . . . | . . . | . . . | . . . | . . . |

For example, Table 4 denotes that a probability that a terminal moves from AR 1 to AR 2 is 30%, a probability that a terminal moves from AR 1 to AR 3 is 40%, a probability that a terminal moves from AR 2 to AR 1 is 20%, and a probability that a terminal moves from AR 2 to AR 3 is 60%. The MA and AR selection unit 205 individually stores, in the storage unit 207, the movement probability information between ARs as in Table 4 with respect to each terminal, stores the movement probability information with respect to each specific terminal group, or stores the movement probability information for each time zone. For example, since a movement direction for each time zone changes as in a user going to or leaving the office, the MA and AR selection unit 205 stores, in the storage unit 207, the movement probability information between ARs with respect to each time zone.

The MA and AR selection unit 205 selects an optimum MA and an optimum AR which minimizes a packet transmission duration time to a terminal after a candidate MA set and a candidate AR set are selected. For example, the MA and AR selection unit 205 calculates a delay time according to a residence time rate of each AR and selects an MA and an AR which minimize an average delay time, as the optimum MA and the optimum AR. In certain embodiments, a residence time rate in each AR is calculated by Equation (1) as follows.

$${R}_{i} = \frac{{{Q}^{{N}_{q}}}_{h = 0} {P}_{ij}^{h} {R}_{j}}{{Q}_{j \vert … \vert A} {{Q}^{{N}_{ij}}}_{h = 0} {P}_{ij}^{h} {R}_{j}} \begin{matrix}if {N}_{ij} = {N}_{h} , {R}_{j} = {R}_{j} = {R}_{,}^{e} \\ if j = i and h = 0 , {R}_{j} = {R}_{j}^{s}\end{matrix} \qquad ( 1 )$$

In certain embodiments, P_{tf}^{h} denotes a probability that a terminal moves from AR i to AR j through h handoffs. For example, P₁₂² denotes a probability that a terminal is handed off from AR 1 to a predetermined another AR and is handed off from the predetermined another AR to AR 2 again. Further, A denotes a candidate AR set considered in a current session. As described above, the number of handoffs (that is, Nₕ) to be considered in a current session is calculated on the basis of the average residence time in each AR and the session average duration time according to a session type, and the candidate AR set is determined on the basis of the calculated number of handoffs. Nᵢⱼ denotes the maximum number of hops when a terminal moves from AR i to AR j. Rⱼ^{e} denotes a time during which a terminal stays in AR j until a session is terminated in AR j, and Rᵢ^{s} denotes a time during which a terminal stays in AR i until the terminal is handed off from a session start time point to another AR when a session starts in AR i. For example, when a residence time rate in each AR is calculated, since a terminal does not transmit a packet for the entire time during which the terminal stays in a session start AR and a session termination AR, a session duration time when a packet is transmitted at each of the session start AR and the session termination AR should be separately calculated. Rⱼ^{e} and Rᵢ^{s} are calculated using a time during which a terminal averagely maintains a session, a time during which the terminal stays at the corresponding AR and an average residence time of each AR to which the terminal is predicted to move during the corresponding session. Rᵢ^{s} is calculated by subtracting a time during which a terminal stays in AR i from an average residence time of AR i where the terminal starts a session. For example, when the average residence time of AR i where a terminal starts a session is 80, and the terminal starts a session after a terminal accesses AR i and a time period of 30 passes, Rᵢ^{s} denotes 50. Further, R_{f}^{e} is calculated by a difference between an average maintenance time of a session and an average residence time of remaining ARs except for AR j where it is predicted that a session is terminated. For example, when an average session maintenance time of a session type requested by the terminal is 320, and an average residence time of remaining ARs except for AR j where it is predicted that a session is terminated is 310, Rⱼ^{e} becomes 10.

The MA and AR selection unit 205 calculates a residence time rate in each AR, and then calculates an average delay time on the basis of a residence time rate as in Equation (2). The MA and AR selection unit 205 selects an MA and an AR, which minimize an average delay time, as an optimum MA and an optimum AR when supporting a packet forwarding scheme and selects an MA, which minimizes an average delay time, as an optimum MA when supporting a path switching scheme.

$$\frac{{{Q}^{{N}_{ij}}}_{h = 0} {P}_{ij}^{h} {R}_{j}}{{Q}_{j \vert … \vert A} {{Q}^{{N}_{ij}}}_{h = 0} {P}_{ij}^{h} {R}_{j}} SC ( j , s , k ) \qquad ( 2 )$$

In certain embodiments. C(j,s,k) denotes a delay time consumed until a packet is transmitted to AR j through a candidate MA k and a candidate AR s when a terminal is accessing AR j. In certain embodiments, since an AR is not selected when a path switching scheme is supported, C(j,s,k) be changed to C(j,k). In certain embodiments, C(j,s,k) or C(j,k) be calculated with reference to Table 5 and/or Table 6.

In various embodiments of the present disclosure, Table 5 denotes information on a delay time consumed for transmitting a packet between the MA and the AR.

TABLE 5

| | AR 1 | AR 2 | AR 3 | . . . |
|---|---|---|---|---|
| MA 1 | 4 | 7 | 11 | . . . |
| MA 2 | 7 | 2 | 8 | . . . |
| MA 3 | 3 | 15 | 7 | . . . |
| . . . | . . . | . . . | . . . | . . . |

For example, Table 5 denotes an example where a delay time consumed for transmitting a packet from MA 1 to AR 1 is 4, a delay time consumed for transmitting a packet from MA 1 to AR 2 is 7, and a delay time consumed for transmitting a packet from MA 1 to AR 3 is 11.

TABLE 6

| | AR 1 | AR 2 | AR 3 | . . . |
|---|---|---|---|---|
| AR 1 | 0 | 2 | 5 | . . . |
| AR 2 | 2 | 0 | 3 | . . . |
| AR 3 | 5 | 3 | 0 | . . . |
| . . . | . . . | . . . | . . . | . . . |

For example, Table 6 denotes an example where a delay time consumed for transmitting a packet from AR 1 to AR 2 is 2, and a delay time consumed for transmitting a packet from AR 1 to AR 3 is 5.

According to various embodiments, as described above, other elements to be considered for transmitting a packet are used instead of a delay time consumed for transmitting a packet.

It has been described above that the MA and AR selection unit 205 calculates a time during which a terminal stays in AR i after a session starts and a time during which a terminal stays in AR j before a session is terminated when a residence time rate in each AR is calculated. As in Table 5 and Table 6, the MA and AR selection unit 205 separately stores, in the storage unit 207, a time during which a terminal stays in each AR after a session starts and a time during which a terminal stays in each AR before a session is terminated, and calculates the residence time rate in each AR on the basis of the times.

According to various embodiments of the present disclosure, Table 7 denotes a time during which a terminal stays in each AR after a session starts.

TABLE 7

AR

| | AR 1 | AR 2 | AR 3 | . . . |
|---|---|---|---|---|
| Time | 50 | 30 | 20 | . . . |

For example, Table 7 denotes that, when a terminal starts a session in AR 1, a time during which the terminal stays in AR 1 is 50, and when the terminal starts a session in AR 2, a time during which the terminal stays in AR 2 is 30.

According to various embodiments of the present disclosure. Table 8 denotes a time during which a terminal stays before a session is terminated.

TABLE 8

AR

| | AR 1 | AR 2 | AR 3 | . . . |
|---|---|---|---|---|
| Time | 25 | 25 | 30 | . . . |

For example, Table 8 denotes an example where, when a terminal terminates a session in AR 1, a time during which the terminal stays in AR 2 before the session is terminated is 25, and when the terminal terminates a session in AR 2, a time during which the terminal stays in AR 2 before the session is terminated is 25. The MA and AR selection unit 205 individually stores, in the storage unit 207, the time during which a terminal stays after a session starts and the time during which a terminal stays before a session is terminated as in Table 5 and Table 6 with respect to each terminal, store the times with respect to each specific terminal group, or store the times for each time zone.

The storage unit 207 stores various types of data and programs required for overall operations of the controller. For example, the storage unit 207 stores the pieces of information as in Table 1 to Table 8 under a control of the MA and AR selection unit 205. For example, the storage unit 207 stores information such as the packet arrival rate for a unit time of each MA, the average session duration time according to a type of a session, the average residence time in each AR, the movement probability information between ARs, the time during which a terminal stays in each AR after a session starts, the time during which a terminal stays in each AR before a session is terminated, a delay time consumed for transmitting a packet between an MA and an AR, and a delay time consumed for transmitting a packet between ARs.

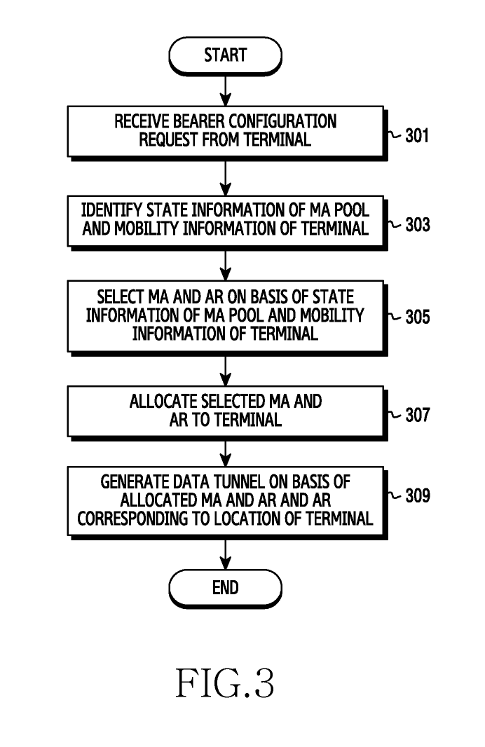

FIG. 3 illustrates a process of operating a controller corresponding to a packet forwarding scheme according to various embodiments of the present disclosure.

Referring to FIG. 3, in step 301, a controller receives a bearer configuration request from a terminal. For example, the controller receives a signal, which requests bearer configuration, from the terminal when the terminal starts a session.

In step 303, the controller 200 identifies state information of an MA pool and mobility information of a terminal. In step 305 the controller 200 selects an MA and an AR on the basis of the state information of the MA pool and the mobility information of the terminal. In more detail, the controller 200 identifies a packet arrival rate for each MA in a pre-stored pack arrival table for each MA and calculates a load rate for each MA on the basis of the packet arrival rate of each MA. The controller 200 selects at least one MA on the basis of the load rate for each MA and configures a candidate MA set including the selected at least one MA. The controller 200 selects at least one candidate AR to which a terminal is predicted to be handed off from a currently connecting AR on the basis of the pre-stored mobility related table (such as Table 2 to Table 4) of a terminal and configures a candidate AR set including the selected AR. After the candidate MA set and the candidate AR set are configured, the controller 200 selects an MA and an AR, which minimize an average delay time according to a residence time rate in each AR, among MAs and ARs which are included in the candidate MA set and the candidate AR set, respectively. For example, the controller selects the MA and the AR, which minimize the average delay time consumed for transmitting a packet to a terminal, as an optimum MA and an optimum AR. The average delay time consumed for transmitting a packet to a terminal is calculated on the basis of Equation (1) and Equation (2).

In step 307, the controller 200 allocates the selected MA and AR to the terminal. In step 309, the controller 200 generates a data tunnel on the basis of the allocated MA and AR and an AR corresponding to a location of the terminal. The controller 200 requests IP allocation of the terminal by the allocated MA such that the terminal receives allocation of an IP from the allocated MA and generate a data tunnel to transmit a packet to the terminal through the allocated MA and AR. The data tunnel is generated on the basis of the allocated MA, the allocated AR, and an AR corresponding to a location of the terminal. For example, the data tunnel is generated to transmit the transmitted packet from the allocated MA via the allocated AR to the terminal through the AR corresponding to the location of the corresponding terminal. The controller registers an IP address of a mobile terminal in an external location management server such that an external terminal firstly transmits a packet to an internal mobile terminal.

The controller 200 terminates a procedure according to various embodiments of the present disclosure.

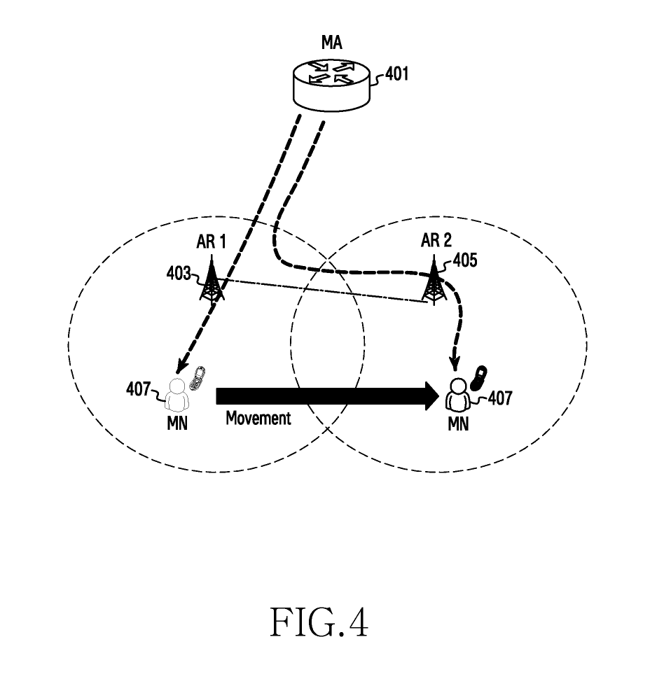

As described above, when the data tunnel is generated by selecting the MA and the AR, the MA and the terminal transmits or receives a packet through the generated data tunnel as illustrated in FIG. 4.

FIG. 4 illustrates a packet transmission path of a packet forwarding scheme according to various embodiments of the present disclosure. A controller (not illustrated) selects an MA 401 and a first AR 403 in consideration of state information of an MA pool and mobility of a terminal 407. When a session of the terminal 407 starts, a data tunnel to a terminal 407 is generated through the selected MA 401 and the selected first AR 403. When the terminal 407 moves to a coverage area of a second AR 405, a new data tunnel is formed between the selected MA 401, the selected first AR 403, and a second AR 405 corresponding to a location of the terminal 407. The terminal 407 performs communication with an external terminal through the MA 401, the first AR 403, and the second AR 405. As described above, in a packet forwarding scheme, the AR selected by the controller and the AR where the terminal is located can be different from each other. In certain embodiments, the packet of the terminal is forwarded from the AR where the terminal is located, to the selected MA, through the selected AR, or is forwarded from the selected MR, to the AR where the terminal is located, through the selected AR.

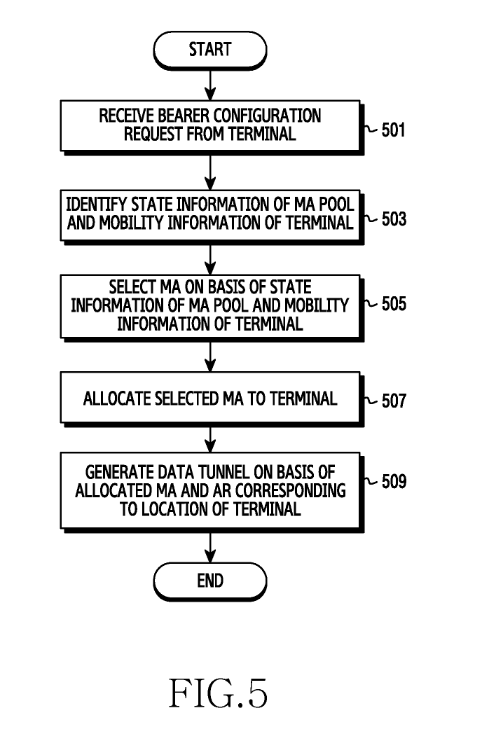

FIG. 5 illustrates a process of operating a controller corresponding to a packet switching scheme according to another embodiment of the present disclosure.

Referring to FIG. 5, in step 501, a controller 200 receives a bearer configuration request from a terminal. For example, the controller 200 receives a signal, which request bearer configuration, from the terminal when the terminal starts a session.

In step 503, the controller 200 identifies state information of an MA pool and mobility information of a terminal. In step 505, the controller selects an MA on the basis of the state information of the MA pool and the mobility information of the terminal. In detail, the controller 200 identifies a packet arrival rate of each MA in a pre-stored packet arrival rate table for each MA, calculates a load rate of each MA using the packet arrival rate of each MA, selects at least one MA on the basis of the calculated load rate, and configures a candidate MA set including the selected at least one MA. After the candidate MA set is configured, the controller 200 selects an optimum MA on the basis of a delay time between each MA included in the candidate MA set and an AR to which a terminal is predicted to be handed off. For example, the controller 200 selects an MA, which minimizes an average delay time consumed for transmitting a packet to a terminal, as an optimum MA. The average delay time consumed for transmitting a packet to a terminal is calculated on the basis of Equation (1) and Equation (2).

In step 507, the controller 200 allocates the selected MA to the terminal. In step 509, the controller 200 generates a data tunnel on the basis of the allocated MA and an AR corresponding to a location of the terminal. The controller 200 requests IP allocation of the terminal by the MA allocated to the terminal such that the terminal receives allocation of an IP from the allocated MA and generate a data tunnel to transmit a packet through the allocated MA and the AR corresponding to the location of the terminal. The controller registers an IP address of a mobile terminal in an external location management server such that an external terminal firstly transmits a packet to an internal mobile terminal.

The controller 200 terminates a procedure according to various embodiments of the present disclosure.

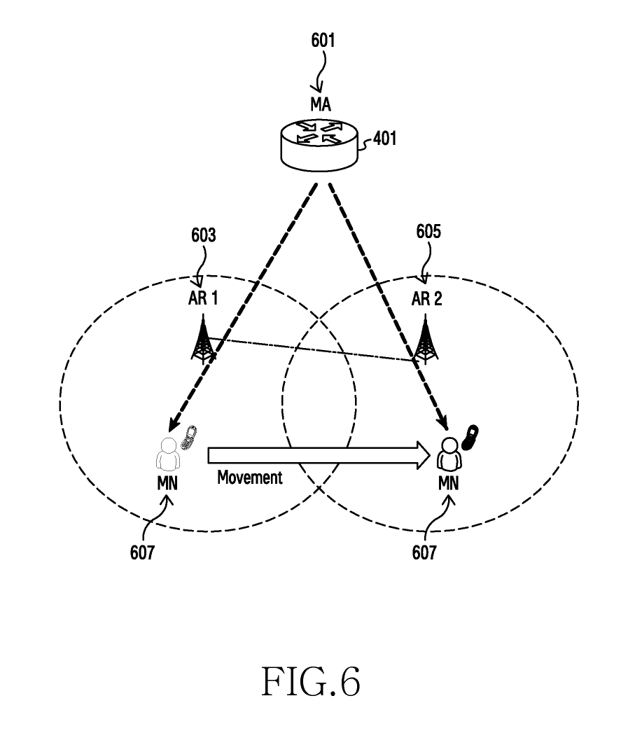

As described above, when the data tunnel is generated by selecting the MA, the MA and the terminal transmits or receives a packet through the generated data tunnel as illustrated in FIG. 6.

FIG. 6 illustrates a packet transmission path of a packet switching scheme according to various embodiments of the present disclosure. A controller (not illustrated) selects an MA 601 in consideration of state information of an MA pool and mobility of a terminal 607. According to various embodiments, when a session of a terminal 607 starts, a data tunnel is generated between the selected MA 601 and a first AR 603. When the terminal 607 moves to a coverage area of a second AR 605, a new data tunnel is formed between the selected MA 601 and the second AR 605. Accordingly, the terminal 607 performs communication with an external terminal through the selected MA 601, and the second AR 605. As described above, in a path switching scheme, the controller 200 selects only an MA and does not select an AR, so that when an access AR of the terminal 607 changes due to a handoff of the terminal 607, the MA switches a packet transmission path into the AR which the terminal 607 hands off, thereby directly transmitting a packet to the corresponding AR.

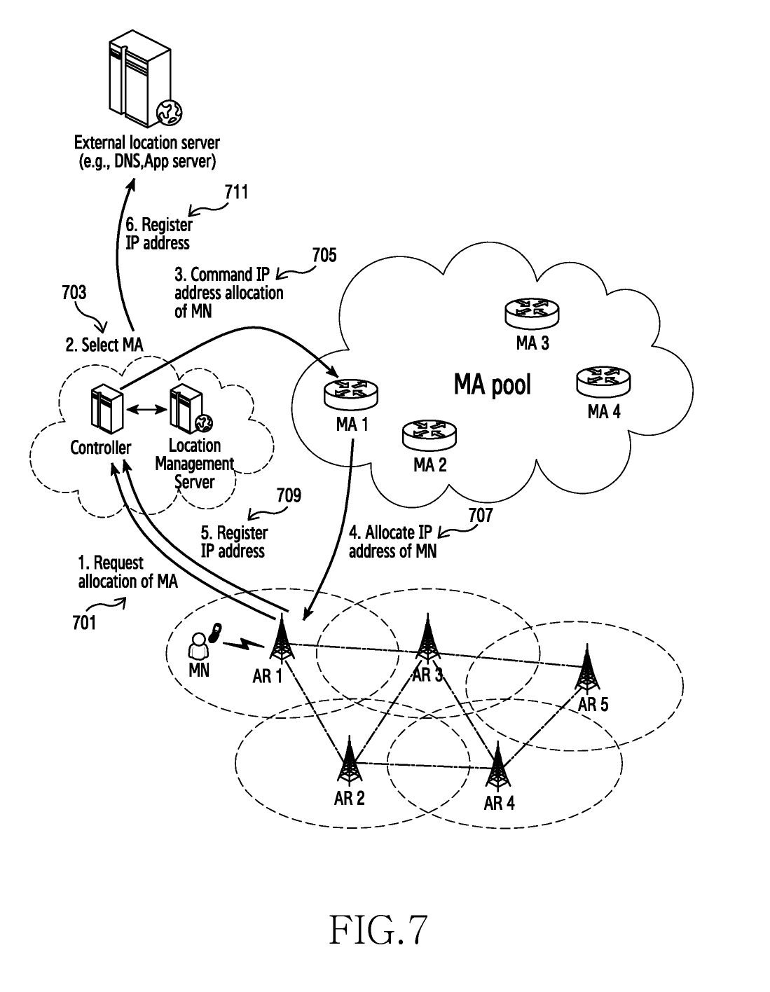

FIG. 7 illustrates an initial access procedure of a terminal in a mobile communication system according to various embodiments of the present disclosure.

Referring to FIG. 7, in step 701, a terminal requests bearer configuration from a controller on a first control plane. The terminal transmits a signal which requests the bearer configuration from the controller when a session starts.

In step 703, when the bearer configuration request is received, the controller selects an optimum MA or an optimum AR for the terminal on the basis of state information of an MA pool and mobility information of a terminal. For example, in a packet forwarding scheme, the controller selects an optimum MA and AR for the terminal on the basis of the state information of the MA pool and the mobility information of the terminal. The controller calculates a load rate of each MA on the basis of a packet reception rate of each MA, which is received from MAs constituting an MA pool and selects a candidate MA set including at least one MA having the calculated load rate lower than a preset threshold load rate. The controller selects a candidate AR set including at least one AR to which the terminal is predicted to be handed off from a currently connecting AR. The controller selects an MA and an AR, which minimize a packet transmission delay time, among MAs and ARs included in the candidate MA set and the candidate AR set, respectively. The delay time includes a delay time between an MA and an AR and a delay time between ARs. As another example, in a packet switching scheme, the controller selects an optimum MA and AR for the terminal on the basis of the state information of the MA pool and the mobility information of the terminal. The controller calculates a load rate of each MA on the basis of a packet reception rate of each MA, which is received from MAs constituting an MA pool and selects a candidate MA set including at least one MA having the calculated load rate lower than a preset threshold load rate. The controller selects an MA which minimizes the packet transmission delay time through an AR to which the terminal is predicted to be handed off, among MAs included in the candidate MA set.

In step 705, the controller makes a command to allocate an IP address of the terminal to the selected MA. In a packet forwarding scheme, the MA receives information on the AR selected for the corresponding terminal. In step 707, the MA, which has received the IP address allocation command, allocate an IP address of an MA through the selected AR or the AR corresponding to the location of the terminal. For example, in a packet forwarding scheme, the MA selects an IP address to be allocated to the terminal among IP addresses of the corresponding MA, and allocate the selected IP address to the corresponding terminal through the AR selected by the controller. As another example, in a path switching scheme, the MA selects an IP address to be allocated to the terminal among IP addresses of the corresponding MA, and allocate the selected IP address to the corresponding terminal through the AR which the terminal is accessing.

In step 709, the terminal registers the IP address of the terminal to a location management server of the controller. The controller and the location management server are configured by one or different devices. In step 711, the controller registers the IP address of a mobile terminal in an external location management server such that an external terminal firstly transmits a packet to an internal mobile terminal.

A data tunnel is generated between the selected MA or AR, and the terminal transmits or receives a packet to or from an external terminal using the generated data tunnel.

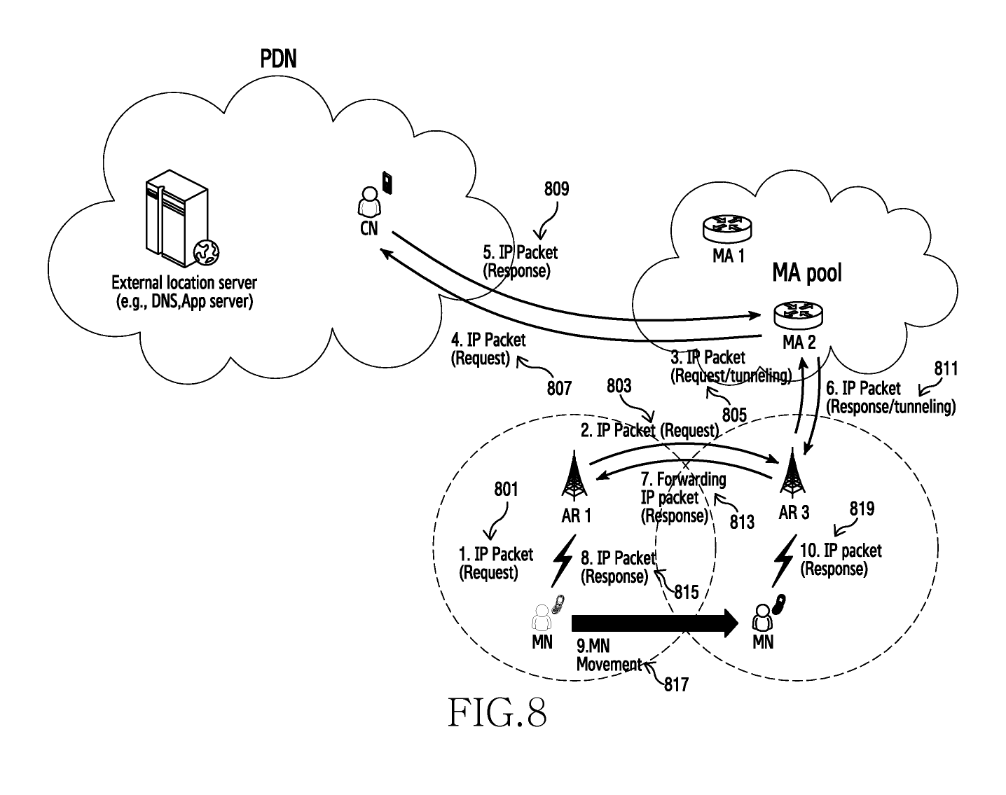

FIG. 8 illustrates signal flow when an internal mobile terminal serves as a client in a packet forwarding scheme according to various embodiments of the present disclosure. In certain embodiments, the description is made on the basis that a second MA and a third AR are selected during an initial access procedure of the terminal.

Referring to FIG. 8, in step 801, the terminal transmits a request packet to a first AR, which the terminal itself accesses, on the basis of the IP address acquired through the initial access procedure. For example, the terminal transmits the request packet including information on the IP address of the terminal itself allocated from an MA, to the first accessing AR. The request packet is a packet corresponding to a predetermined request message which requires a response of a server.

In step 803, the first AR transmits the request packet received from the terminal, to a third AR. The third AR denotes an AR allocated by the controller during the initial access procedure. According to various embodiments, an AR that the terminal is accessing and an AR allocated by the controller at the initial access procedure are identical ARs.

In step 805, the third AR transmits the request packet to the second MA allocated by the initial access procedure.

In step 807, the second MA transmits the received request packet to a Client Node (CN) of an external PDN (operation 807). The second MA transmits the request packet to the external server of the PDN or the CN managed by the external server.

The CN, which has received the request packet of the terminal, transmits, to the terminal, a response packet through the data tunnel generated by the initial access procedure in step 809 to 813. For example, the response packet, which is transmitted by the CN, is transmitted to the corresponding terminal through the second MA and the third AR. When the terminal is located in a coverage area of the first AR, the response packet of the CN is transmitted to the third AR through the second MA, and is then transmitted from the third AR to the first AR, so that the response packet is transmitted to the corresponding terminal. In step 815, when the terminal moves from the coverage of the first AR to a coverage area of the third AR in step 817, the response packet of the CN is transmitted to the third AR through the second MA, and is then directly transmitted from the third AR to the terminal.

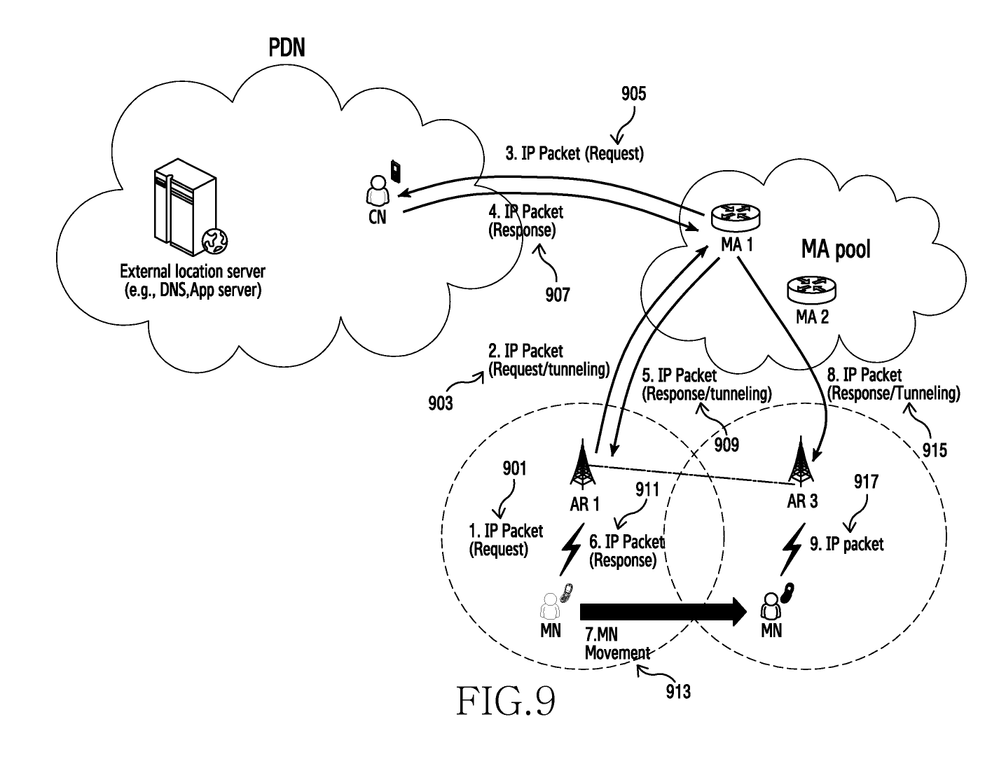

FIG. 9 illustrates signal flow when an internal mobile terminal serves as a client in a path switching scheme according to another embodiment of the present disclosure. In certain embodiments, the description is made on the basis that a first MA is selected and an AR is not selected during an initial access procedure.

Referring to FIG. 9, in step 901, the terminal transmits a request packet to a first AR, which the terminal itself is accessing, using the IP address acquired through the initial connection procedure. For example, the terminal transmits the request packet including information on the IP address of the terminal itself allocated from a first MA, to the first accessing AR. The request packet is a packet corresponding to a predetermined request message which requires a response of a server.

In step 903, the first AR transmits the request packet received from the terminal, to the first MA. In step 905, the first MA transmits the received request packet to a CN of a PDN. The first MA transmits the request packet to the external server of the PDN or the CN managed by the external server.

The CN, which has received the request packet of the terminal, transmits, to the terminal, a response packet through the data tunnel generated at the initial access procedure in steps 907 to 911. For example, the response packet, which is transmitted by the CN, is transmitted to the AR, which the terminal is accessing, through the first MA, and is then transmitted from the corresponding AR to the corresponding terminal. In step 913, when the terminal is located in a coverage area of the first AR, the response packet of the CN is transmitted to the first AR through the first MA, and is then transmitted from the first AR to the corresponding terminal. In step 917. When the terminal moves from the coverage of the first AR to the coverage area of the third AR in step 915, the response packet of the CN is transmitted to the third AR through the first MA, and is then transmitted from the third AR to the terminal.

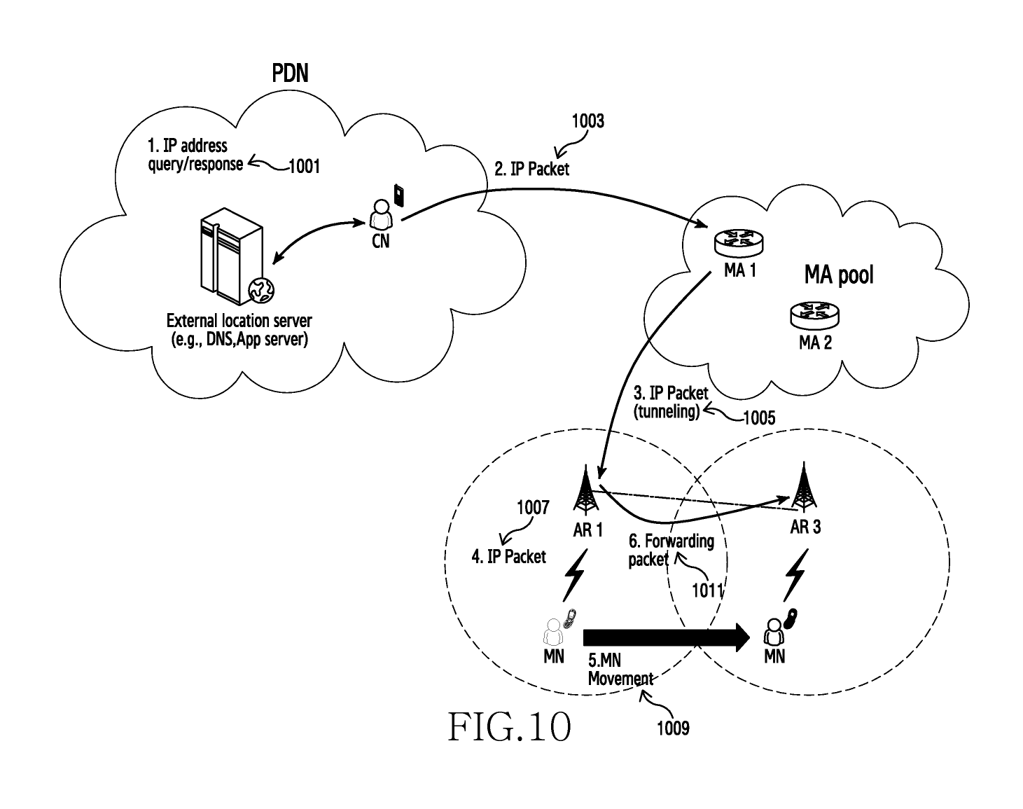

FIG. 10 illustrates signal flow when an internal mobile terminal serves as a server in a packet forwarding scheme according to various embodiments of the present disclosure.

In FIG. 10, the description is made on the basis that an IP address acquired by the terminal at an initial connection procedure has been registered in an external DNS or a separate location management server in order to notify a location of an internal mobile terminal to an external terminal. Further, the description is made on the basis that a first MA and a first AR are selected at an initial connection procedure of the terminal.

Referring to FIG. 10, in step 1001, the CN identifies information on an IP address of a mobile terminal with which the CN wants to communicate through a Domain Name Server (DNS) or a location management server.

In step 1003, the CN transmits a request packet from the DNS or the location management server to the first MA corresponding to the terminal on the basis of the identified IP address.

The first MA transmits the request packet to the terminal through the generated data tunnel at an initial access procedure in step 1005 and step 1007). The first MA transmits the request packet received from the CN to the first AR selected at an initial access procedure, and the first AR transmits the received request packet to the terminal.

When the terminal is accessing the first AR at the initial access procedure and then moves to a coverage area of the third AR in step 1009, a data tunnel is generated between the first MA, the first AR, and the third AR. In step 1011, the first AR transmits the request packet received from the first MA to the third AR, and the third AR transmits the request packet received from the first AR to the terminal.

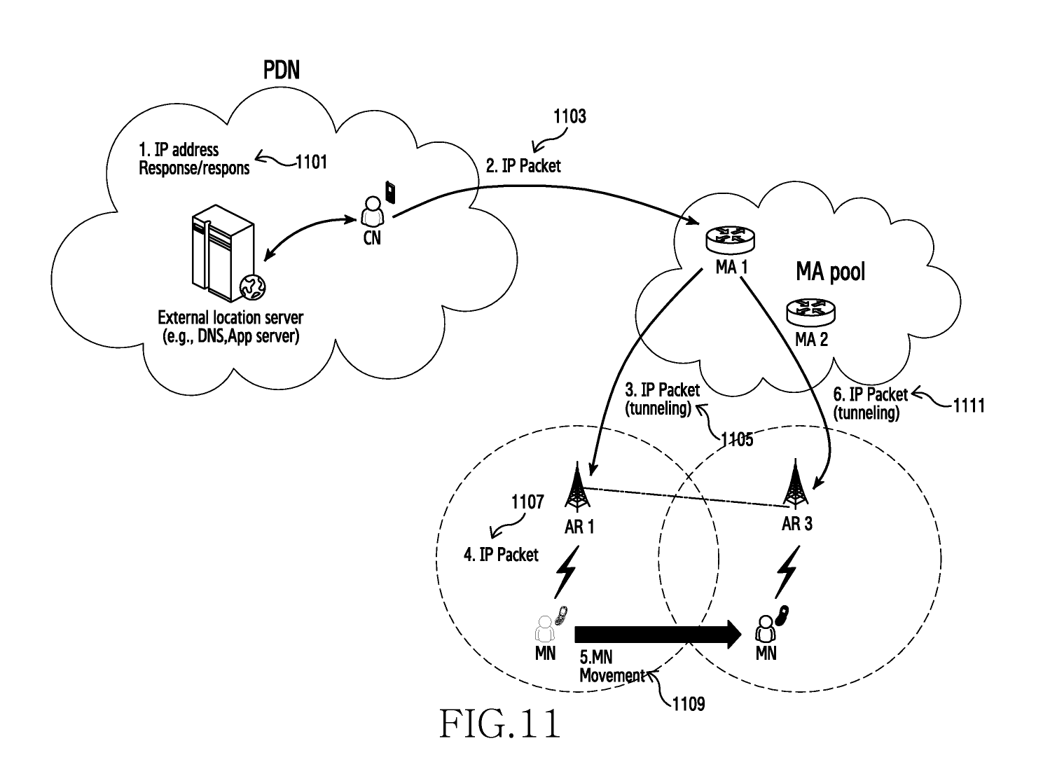

FIG. 11 illustrates signal flow when an internal mobile terminal serves as a server in a path switching scheme according to various embodiments of the present disclosure.

In FIG. 11, the description is made on the basis that an IP address acquired by the terminal during an initial connection procedure has been registered in an external DNS or a separate location management server in order to notify a location of an internal mobile terminal to an external terminal. The description is made on the basis that the first MA is selected during the initial access procedure of the terminal.

Referring to FIG. 11, in step 1101, the CN identifies information on an IP address of a mobile terminal with which the CN wants to communicate through a DNS or a location management server.

In step 1103, the CN transmits a request packet from the DNS or the location management server to the first MA corresponding to the terminal on the basis of the identified IP address.

The first MA transmits the request packet to the terminal through the generated data tunnel in step 1105 and step 1107). The first MA transmits the request packet received from the CN to the first AR that the terminal is accessing, and the first AR transmits the received request packet to the terminal.

When the terminal is accessing the first AR at the initial access procedure and then moves to a coverage area of the third AR in step 1109, a data tunnel is generated between the first MA, and the third AR. In step 1111, the first MA transmits the request packet received from the CN to the third AR, and the third AR transmits the received request packet to the terminal.

As described above, the present disclosure selects an MA or an AR on the basis of the load information of an MA and the mobility information of a terminal, thereby maximizing a load balancing effect of the MA and minimizing time consumed while transmitting a packet to the terminal. For example, it is predicted that the terminal starts a session in AR 1, stays in AR 1 during a time period T1, moves to AR 2, stays in AR 2 during a time period T2, moves to AR 3, and stays in AR 3 during a time period T3. When T1<T3<T2, in the related art, the terminal selects an MA closest to AR 1 where a session starts regardless of each AR and a staying time. According to various embodiments of the present disclosure, the terminal selects an MA on the basis of AR 2 which is predicted to be stayed in for the longest time period T2, thereby minimizing a time consumed for transmitting a packet to the terminal. When T1<T2=T3, in the related art, the terminal selects an MA closest to AR 1 where a session starts regardless of each AR and staying time. According to various embodiments of the present disclosure, the terminal selects AR 1, AR 2, and AR 3, which are predicted to move within a session of the terminal and an MA having the shortest packet transmission delay time among MAs corresponding to AR 2 and AR 3 which are stayed in during the same time period, thereby minimizing a time consumed for transmitting a packet to the terminal.

Although a detailed description of the present disclosure is made with regard to a detailed embodiment, a system, an apparatus, and a method disclosed in the present specification may be modified, added, or omitted without departing from the scope of the present disclosure. For example, a component of the system and the apparatus may be coupled or separated. In addition, an operation of the system and the apparatus may be executed by more apparatuses, fewer apparatuses, or other apparatuses. The method may include more operations, fewer operations, or other operations. Further, the operations may be coupled or executed in a different predetermined proper sequence.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

Although the present disclosure is disclosed as an exemplary embodiment, various changes and modifications may be proposed by those skilled in the art. The present disclosure is intended to include modifications and changes belonging to added claims.

What is claimed is:

1. A method of operating a controller that selects a mobility anchor (MA) in a mobile communication system, the method comprising:
receiving a bearer configuration request signal from a terminal;
acquiring load information for each of a plurality of MAs and mobility information of the terminal; and
determining an MA of the terminal based on the load information of each of the plurality of MAs and the mobility information of the terminal.

2. The method of claim 1, further comprising:
determining an access router (AR) of the terminal based on the load information of each of the plurality of MAs and the mobility information of the terminal.

3. The method of claim 1, wherein the load information of each of the plurality of MAs is determined based on a packet arrival rate for each MA.

4. The method of claim 1, wherein the mobility information of the terminal comprises at least one of an average session duration time according to a type of a session, an average residence time of a terminal for each AR, a movement probability between ARs, a time during which a terminal stays in each AR after a session starts, a time during which a terminal stays in each AR before a session is terminated, a packet transmission delay time between an MA and an AR and a packet transmission delay time between ARs.

5. The method of claim 4, wherein the mobility information of the terminal is acquired for each terminal, for each terminal group, and for each time zone.

6. The method of claim 4, wherein determining the MA of the terminal based on the load information for each of the plurality of MAs and the mobility information of the terminal comprises:
selecting a plurality of candidates MAs based on the load information for each of the plurality of MAs;
calculating a residence time rate in each AR, to which the terminal is predicted to move, based on the mobility information of the terminal; and
determining an MA, which minimizes an average delay time consumed for transmitting a packet to the terminal among the plurality of candidate MAs, as an MA of the terminal, based on the calculated residence time rate in each AR.

7. The method of claim 4, wherein determining the MA of the terminal based on the load information for each of the plurality of MAs and the mobility information of the terminal comprises:
selecting a plurality of candidate MAs based on the load information for each of the plurality of MAs;
selecting a plurality of candidate ARs based on the mobility information of the terminal;
calculating a residence time rate in each AR, to which the terminal is predicted to move, based on the mobility information of the terminal; and
determining an MA and an AR, which minimize an average delay time consumed for transmitting a packet to the terminal among the plurality of candidate MAs and the plurality of candidate ARs, as an MA and an AR of the terminal, based on the calculated residence time rate in each AR.

8. The method of claim 7, wherein selecting the plurality of candidate ARs based on the mobility information of the terminal comprises:
calculating the number of handoffs which is predicted to be performed by the terminal, based on an average residence time in each AR and an average session duration time corresponding to a session type requested by the terminal; and
selecting a plurality of candidate ARs based on the calculated number of handoffs.

9. The method of claim 1, further comprising:
requesting allocation of an IP address of the terminal from the determined MA;
receiving information on the IP address of the terminal from an AR that the terminal is accessing; and
registering the received information on the IP address of the terminal in an external server.

10. The method of claim 2, further comprising:
transmitting information on the determined AR of the terminal to the determined MA, and requesting transmission of a related packet to the terminal through the determined AR.

11. An apparatus for selecting a mobility anchor (MA) in a mobile communication system, the apparatus comprising:
a transmission/reception unit configured to receive a bearer configuration request signal from a terminal; and
a controller configured to:
acquire load information for each of a plurality of MAs and mobility information of a terminal, and
determine an MA of the terminal based on the load information of each of the plurality of MAs and the mobility information of the terminal.

12. The apparatus of claim 11, wherein the controller is further configured to determine an access router (AR) of the terminal based on the load information for each of the plurality of MAs and the mobility information of the terminal.

13. The apparatus of claim 11, wherein the controller is further configured to determine load information for each of the plurality of MAs based on a packet arrival rate for each MA.

14. The apparatus of claim 11, wherein the mobility information of the terminal comprises at least one of an average session duration time according to a type of a session, an average residence time of a terminal for each AR, a movement probability between ARs, a time during which a terminal stays in each AR after a session starts, a time during which a terminal stays in each AR before a session is terminated, a packet transmission delay time between an MA and an AR, and a packet transmission delay time between ARs.

15. The apparatus of claim 14, wherein the controller is further configured to acquire and store the mobility information of the terminal with respect to each terminal, with respect to each terminal group, and with respect to each time zone.

16. The apparatus of claim 14, wherein the controller is further configured to:
select a plurality of candidate MAs based on the load information for each of the plurality of MAs,
calculate a residence time rate in each AR, to which the terminal is predicted to move, based on the mobility information of the terminal, and
determine an MA, which minimizes an average delay time consumed for transmitting a packet to the terminal, among the plurality of candidate MAs, as an MA of the terminal, based on the calculated residence time rate.

17. The apparatus of claim 14, wherein the controller is further configured to:
select a plurality of candidate MAs based on the load information for each of the plurality of MAs,
select a plurality of candidate ARs based on the mobility information of the terminal,
calculate a residence time rate in each AR, to which the terminal is predicted to move, based on the mobility information of the terminal, and
determine an MA and an AR, which minimize an average delay time consumed for transmitting a packet to the terminal, among the plurality of candidate MAs and the plurality of candidate ARs based on the calculated residence time rate in each AR.

18. The apparatus of claim 17, wherein the controller is further configured to:
calculate the number of handoffs, which is predicted to be performed by the terminal, based on an average residence time in each AR and an average session duration time corresponding to a session type requested by the terminal, and
select a plurality of candidate ARs based on the calculated number of handoffs.

19. The apparatus of claim 11, wherein the controller is further configured to:
request allocation of an IP address of the terminal from the determined MA,
receive information on the IP address of the terminal from an AR that the terminal is accessing, and
register the received information on the IP address of the terminal in an external server.

20. The apparatus of claim 12, wherein the controller is further configured to:
transmit information on the determined AR of the terminal to the determined MA, and
request transmission of a related packet to the terminal through the determined AR.
